(19) United States
(12) Patent Application Publication
(10) Pub. No.: US 2006/0163330 A1
(43) Pub. Date: Jul. 27, 2006

(54) SITE FLATTENING TOOL AND METHOD FOR CIRCUIT BOARD REPAIR

(75) Inventors: Brian D. Chapman, Poughkeepsie, NY (US); James J. Petrone, Hyde Park, NY (US); Nandakumar N. Ranadive, Wappingers Falls, NY (US)

Correspondence Address: SCULLY, SCOTT, MURPHY & PRESSNER, P.C., 400 GARDEN CITY PLAZA, Suite 300, GARDEN CITY, NY, 11530, US

(73) Assignee: INTERNATIONAL BUSINESS MACHINES CORPORATION, Armonk, NY (US)

(21) Appl. No.: 10/905,919

(22) Filed: Jan. 26, 2005

(51) Int. Cl. B23K 31/02

(52) U.S. Cl. 228/119; 228/19

(57) ABSTRACT

Disclosed are a tool and a procedure for flattening a site on a printed circuit board. The tool comprises three sections: a nozzle, a throat and a flattening block. The nozzle connects the tool to a hot air source and receives hot air from said source, and the throat is connected to the nozzle section for receiving the hot air from the nozzle section. The flattening block has a generally planar bottom surface for engaging a site on a printed circuit board. The flattening block forms a vent for venting the hot air from the flattening block to the ambient to help maintain said site at an approximately constant temperature when said bottom surface engages said site. A resilient mechanism is mounted on the throat section, for forcing said bottom surface against said site, with a constant, known force.

### BACKGROUND OF THE INVENTION

1. Field of the Invention

This invention generally relates to repairing integrated circuit boards; and more specifically, the invention relates to a tool and a procedure for flattening warped sites on an integrated circuit.

2. Background Art

Forming an electronic package assembly whereby an electrical component such as an integrated circuit chip is electrically and mechanically connected to a substrate such as a card, or board, another chip or another electronic part is well-known in the art. This technology is generally termed surface mount technology (SMT) and has gained acceptance as the preferred means of joining electronic package assemblies. In one particular application, multiplayer ceramic components, as exemplified by integrated circuit chips, are joined to printed circuit cards or boards.

Multilayer ceramic electronic components are typically joined to printed circuit boards by soldering pads on a surface of one of the electronic components to corresponding pads on the surface of the other component. Control Collapse Chip Connection is an interconnect technology developed by IBM as an alternative to wire bonding. This technology is generally known as C4 technology or flip chip packaging. Broadly stated, an integrated circuit chip is mounted above a board and pads on the chip are electrically and mechanically connected to corresponding pads on the board by a plurality of electrical connections such as solder bumps. The integrated circuit chips may be assembled in an array such as a 10×10 array.

In the C4 interconnect technology; a relatively small solder bump is attached to the pads on one of the components being joined to the chip. The electrical and mechanical interconnects are then formed by positioning the corresponding pads on the board to be joined adjacent the solder bumps on the chip and reflowing the bumps at an elevated temperature. The C4 joining process is self-aligning in that the wetting action of the solder will align the chip bump pattern to the corresponding board pads.

A myriad of solder structures have been proposed for the surface mounting of one electronic structure to another. With one well known procedure, a ceramic ball grid array (BGA) and ceramic column grid array (CCGA) are used to connect the structures together to form an assembly. By using solder balls, a very exact and large quantity of solder can be applied. The solder balls are aligned and are held to a substrate and melted to form a solder joint on a conductive pad of the substrate. The substrate with the newly joined solder balls is aligned to the board to be connected therewith and the solder balls are then reflowed to form a solder bond between the two substrates. The use of a copper ball surrounded by eutectic solder is also used as a solder joint structure for attaching a multiplayer ceramic (MLC) substrate to a PC laminate where the ball serves as a standoff. Solder columns are also used to form solder interconnections as is well-known in the art and are generally termed a ceramic column grid array (CCGA).

A variety of soldering/desoldering machines are known for attachment and detachment of electrical circuit components particularly from areas of crowded printed circuit boards where the components are adjacent to other closely-spaced soldered components which are not to be disturbed.

It is necessary to repair printed circuit boards from time to time. BGA/CCGA rework is a form of rework which is done by heating a specific site using localized heating to a temperature sufficient to remove one or more of the chips connected to the circuit board. Temperatures of 195-220° C. are typically used to melt the solder connections to remove the chip to be replaced. Typically, the glass transition temperature (Tg) of a conventional FR4 printed circuit board is about 130° C. and for some high FR4 Tg materials is about 170° C. Since the circuit board material (epoxy) in the locally heated area exceeds the Tg of the board, there is a likelihood of site warpage. If the site bows to an extent that the corner to center difference in flatness is more than 4 mils, subsequent attachment is sometimes unreliable. There is a risk that some of the solder joints may show poor wetting. It is, therefore, necessary to flatten these sites.

### SUMMARY OF THE INVENTION

An object of this invention is to provide a tool and procedure for flattening a warped site on a printed circuit board.

Another object of the present invention is to provide a tool that can use existing heating sources, which are used to rework printed circuit boards, for flattening warped sites on a printed circuit board.

A further object of the invention is to provide a multi-section tool that can apply a constant, known force and a uniform, constant temperature to a warped area of a printed circuit board.

These and other objectives are attained with a tool and procedure for flattening a site on a printed circuit board. The tool comprises three sections: a nozzle section, a throat section and a flattening block section. The nozzle section is provided for connecting the tool to a hot air source and for receiving hot air from said source, and the throat section is connected to the nozzle section and extends therefrom for receiving the hot air from the nozzle section. The flattening block section has a generally planar bottom surface for engaging a site on a printed circuit board.

The flattening block forms (i) an internal recess receiving the throat section and in fluid communication with the throat section for receiving the hot air therefrom, and (ii) a vent opening for venting the hot air from the flattening block to the ambient to help maintain said site at an approximately constant temperature when said bottom surface engages said site. A resilient mechanism is mounted on the throat section, between the nozzle section and bottom surface of the flattening block, for forcing said bottom surface against said site, with a constant, known force, when said bottom surface engages said site of the printed circuit board.

The preferred embodiment of the invention, described in detail below, can utilize the heating source outlet of known re-work system. This tool has heat channels inside that allow the hot gas to flow freely and maintain a uniform, constant temperature. Preferably, the tool is fitted with a spring mechanism that will impart a constant force during the flattening cycle. A preferred tool embodying this invention has been verified to yield consistent flatness on warped boards. Typically, a board that is warped 5 mils or more from center to the edge of the site, can be brought to within 0.5 mils using a preferred site flattening tool and procedure of this invention.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 shows a site flattening tool embodying teachings of the present invention.

FIG. 2 is an exploded view of the tool of FIG. 1.

FIG. 3 is a side view showing the tool of FIGS. 1 and 2 in use.

FIG. 4 is a flow chart illustrating a procedure, using the tool of FIGS. 1-3, to flatten a warped area on a circuit board.

### DETAILED DESCRIPTION OF THE PREFERRED EMBODIMENTS

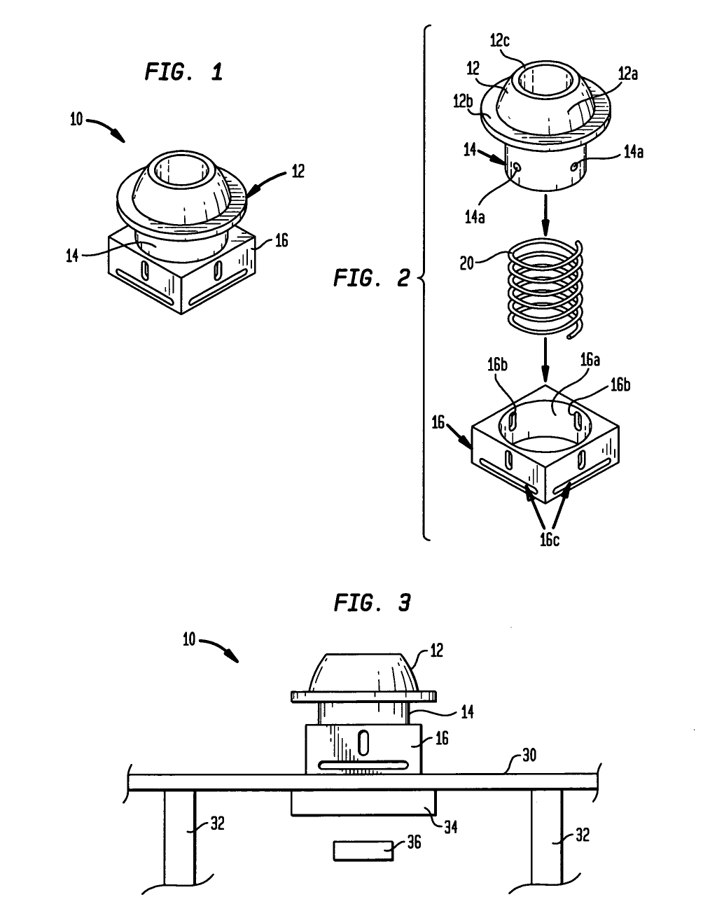

In describing the preferred embodiment of the invention, reference will be made herein to FIGS. 1-4 of the drawings, in which like numerals refer to like features of the invention. Features of the invention are not necessarily shown to scale in the drawings.

With particular reference to FIGS. 1 and 2, a preferred embodiment of tool 10 is comprised of three sections: nozzle section 12, throat section 14, and flattening head 16. Nozzle section 12 is designed to adapt to a heating source outlet (not shown), and any suitable heating source can be used in the practice of this invention. This nozzle section 12 has a main portion 12a that has a curved, conical shape, curving upwardly inwardly, and includes lower rim 12b and upper edge 12c. As those of ordinary skill in the art will recognize, nozzle section 12 can be easily modified to adapt to many conventional rework heating sources. Also, the nozzle section 12 may be made from any appropriate material, and any suitable procedure may be used to form the nozzle section.

The second section of tool 10 is throat section 14, which houses spring 20. Throat section 14 has a tubular shape, is connected to a bottom portion or surface of nozzle section 12, and extends downward from the nozzle section. The throat section 14 has a hollow interior, and the sides of the throat section form a plurality of ports 14a in communication with that interior. The throat section 14 may be made of any suitable material and formed in any suitable way. Also, the throat section 14 may be connected to the nozzle section 12 in any suitable manner; and, for instance, the throat section may be integral with the nozzle section or may be soldered or welded thereto.

In tool 10, spring 20 is disposed in the interior of throat section 14. Preferably, the spring is made of a stainless steel material. The spring properties (spring constant, material, thickness, etc.) are selected to meet the requirements of the circuit board material to be flattened. Depending upon the Tg and the compressive strength of the laminate material of the circuit board, different forces may be used. Spring 20 is selected such that when the flattening tool 10 is fully compressed, a known force is applied to the laminate material of the circuit board.

The third section of the tool 10 is the flattening head 16. As shown in FIGS. 1 and 2, head 16, generally, has a box or cube shape with a central through opening 16a for slidably receiving throat section 14. The inside surface of the head section forms a series of channels 16b which allow the hot gas to flow freely and to exhaust from side vents 16c. The head section 16 may be made of any appropriate material and formed in any suitable manner. Any suitable procedure may be used to connect nozzle 12 and throat 14 to block 16. For instance, a standard chuck connection may be used to do this.

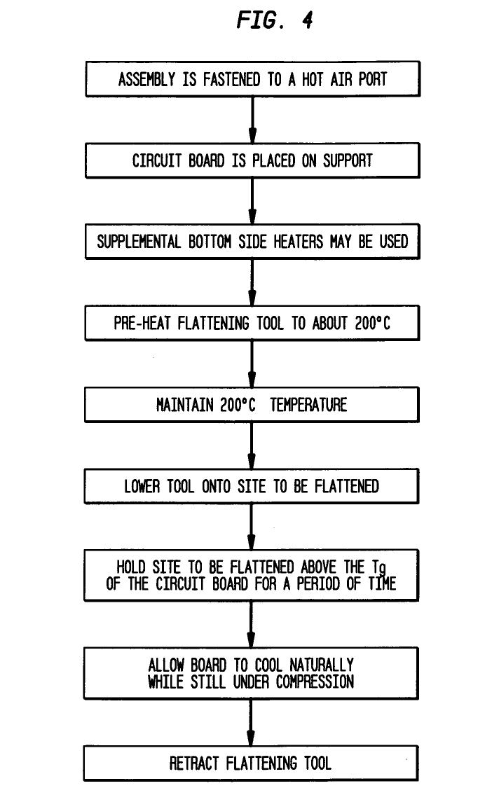

With reference to FIGS. 3 and 4, to use the invention, assembly 10 is fastened in any suitable way to the hot air ports of a rework tool (not shown). The printed circuit board 30 is placed on appropriate supports, represented at 32, which provide sufficient stability for the circuit board. Another flat block 34 may be placed under the site to be flattened. A supplemental bottom side heater, represented at 36, is preferably used to raise the board to a global temperature of about 130° C.

The site flattening tool 10 is pre-heated to about 200° C., and hot air flow is monitored so that this temperature remains constant within ±5° C. The tool 10 is then lowered on to the BGA/CCGA site to be flattened. Spring loaded mechanism 10 allows a predetermined load to be applied to the board.

A thermal profile is developed such that the site to be flattened is held above the Tg of the circuit board 30 for about five minutes. At the end of this time, the heaters are turned off and the board is allowed to cool naturally, while still under compression. Once cool, the flattening tool 10 is retracted and the site flatness is re-measured. If desired, the above process may be repeated to further flatten the site. It has been found that, in a number of procedures using the present invention, no more than two attempts were needed to flatten the reworked site to within one mil.

While it is apparent that the invention herein disclosed is well calculated to fulfill the objects stated above, it will be appreciated that numerous modifications and embodiments may be devised by those skilled in the art and it is intended that the appended claims cover all such modifications and embodiments as fall within the true spirit and scope of the present invention.

What is claimed is:

1. A site flattening tool for a printed circuit board repair, comprising:
a nozzle section for connecting the tool to a hot air source and for receiving hot air from said source;
a throat section connected to the nozzle section and extending therefrom for receiving the hot air from the nozzle section;
a flattening block having a generally planar bottom surface for engaging a site on a printed circuit board, and forming
i) an internal recess receiving the throat section and in fluid communication with the throat section for receiving the hot air therefrom, and
ii) a vent opening for venting the hot air from the flattening block to the ambient to help maintain said site at an approximately constant temperature when said bottom surface engages said site; and
a resilient mechanism in said recess, between the nozzle section and said bottom surface, for forcing said bottom surface against said site, with a constant, known force, when said bottom surface engages said site of the printed circuit board.

2. A tool according to claim 1, wherein the resilient mechanism includes a spring.

3. A tool according to claim 2, wherein said spring is a coil spring mounted on said throat section and captured between the nozzle section and said bottom surface of the flattening block.

4. A tool according to claim 1, wherein the flattening block includes an inside surface forming said recess, and also forming a plurality of channels for conducting the hot air flow from the throat section to said vent opening.

5. A tool according to claim 4, wherein the vent opening includes a plurality of side vents extending outward from said recess and in fluid communication with the ambient for conducting the hot air flow from the flattening block and to the ambient.

6. A tool according to claim 1, wherein:
the nozzle section forms
i) a top inlet for receiving the hot air from said source, and
ii) an internal cavity for conducting the hot air from said top inlet and through the nozzle section;
the throat section forms
i) an internal passage for receiving the hot air from the nozzle section, and
ii) a plurality of outlet ports for conducting the hot air outward from said internal passage and from said throat section;
the vent opening of the flattening block includes
i) a plurality of channels extending along said recess to receive the hot air from said outlet ports, and
ii) a plurality of side vents in fluid communication with said channels and with the ambient for conducting the hot air from said channels to the ambient.

7. A method of flattening a site on a printed circuit board, comprising the steps:
providing a flattening tool having a spring mechanism;
connecting the flattening tool to a hot air source;
raising the temperature of a given area of the printed circuit board to a first temperature;
using hot air from the hot air source to pre-heat the flattening tool to a second temperature;
engaging the site on the printed circuit board with the flattening tool;
using the spring mechanism of the flattening tool to apply a predetermined load to said site;
holding said site at a temperature above Tg for a defined amount of time; and
cooling the printed circuit board while maintaining said predetermined load on said site.

8. A method according to claim 7, wherein the step of using hot air from the hot air source includes the step of using said hot air also to maintain the temperature of the flattening tool approximately at said second temperature for a defined period of time.

9. A method according to claim 8, wherein the step of using hot air from the hot air source includes the steps of:
conducting a hot air flow from said source to said tool; and
monitoring said hot air flow to maintain the temperature of the flattening tool approximately at said second temperature for said defined period of time.

10. A method according to claim 9, wherein the step of using hot air from the hot air source includes the further step of venting the hot air flow from the tool.

11. A method according to claim 10, wherein:
said tool includes a nozzle section, a throat section, and a flattening head section;
the step of conducting a hot air flow from said source and to said tool includes the step of conducting the hot air flow from said source, through said nozzle section, and into the throat section; and
the step of venting the hot air flow from the tool includes the step of conducting the hot air flow through the throat section and into the flattening head section, and venting the hot air flow through the flattening head section and into the ambient.

12. A method according to claim 11, wherein said first temperature is below Tg.

13. A method of flattening a warped site on a printed circuit board, comprising the steps of:
providing a flattening tool having a spring mechanism;
connecting the flattening tool to a hot air source;
raising the temperature of the warped site on the printed circuit board to a first temperature level;
using hot air from the hot air source
i) to pre-heat the flattening tool to a second temperature level, and
ii) to maintain the temperature of the flattening tool within a predetermined range of said second temperature level for a defined period of time;
engaging the warped site on the printed circuit board with the flattening tool, including the steps of
i) using the spring mechanism of the flattening tool to apply a predetermined load to said warped site, and
ii) using the flattening tool to hold said site at a temperature above Tg for a defined period of time; and
cooling the printed circuit board while maintaining said predetermined load said warped site.

14. A method according to claim 13, wherein:
said first temperature level is approximately 130 C; and
said second temperature level is approximately 200 C.

15. A method according to claim 14, wherein said predetermined range is ±5 C.

16. A method according to claim 13, wherein:
said flattening tool comprises a nozzle section, a throat section, and a flattening head; and
said spring mechanism includes a resilient member captured inside the flattening tool, below the nozzle section.

17. A method according to claim 16, wherein said resilient member includes a coil spring mounted on the throat section.

18. A method according to claim 17, wherein:
the connecting step includes the step of connecting the nozzle section to the hot air source;
the engaging step includes the step of engaging said site on the printed circuit board with the flattening head; and
the step of using hot air includes the steps of
i) conducting a hot air flow from said source, through the nozzle section, through the throat section and into the flattening head, and
ii) venting the hot air flow from the flattening head.
